(19) United States
(12) Patent Application Publication
(10) Pub. No.: US 2011/0232193 A1
(43) Pub. Date: Sep. 29, 2011

(54) RF-remote control, retrofitted, self-contained, automatic window opener for casement windows or the like

(76) Inventor: Kenneth William Thorne, Carbondale, CO (US)

(21) Appl. No.: 12/798,038

(22) Filed: Mar. 29, 2010

(51) Int. Cl. E05F 15/12; G08C 19/12

(52) U.S. Cl. 49/70

(57) ABSTRACT

An RF (radio frequency)-remote control, retrofitted, self-contained, automatic window opener is provided for casement windows or the like which includes a housing having a DC motor therein which has a power shaft extending therefrom. The DC motor is powered by a battery source contained within the housing. The power shaft of the DC motor is selectively removably secured to the drive shaft of a conventional casement window opener mechanism so that the DC motor may rotate the drive shaft in either direction to open or close the sash of the casement window. The window opener of this invention is mounted within a housing which has anti-rotation members selectively adjustably extending therefrom which engage the window frame to prevent rotation of the unit when the motor is activated. The unit includes an electrical circuit which has an RF (radio frequency) receiver associated therewith which is controllable by a remote RF (radio frequency) transmitter to enable a person to remotely control the opening and closing of a casement window.

### BACKGROUND OF THE INVENTION

1. Field of the Invention

This invention relates to an opener for a casement window more particularly to an opener which is designed to open casement windows automatically, with an RF (radio frequency) signal, activating a single fully self-contained or multiple fully self-contained units which may be placed on windows in different locations and/or on different floors and which are controlled by a hand-held or wall-mounted remote controller or electronic timer.

2. Description of the Related Art

Casement windows have been widely used for many years. Generally speaking, most casement windows include a window sash which is pivotably movably mounted in a window frame. Casement windows normally employ a hand crank that drives a worm gear with the worm gear being meshed with a gear segment which is part of a lever or linkage assembly that is connected to the sash. When the crank is turned, the worm gear causes the gear segment and lever to move to cause the sash to pivot on its hinges between open and closed positions. The inner end of the crank usually includes a female, splined-socket which is selectively removably mounted on a male splined shaft which is operatively connected to the worm gear.

Although many remotely controlled mechanisms have been provided for a window operator for use in moving a casement window sash between open and closed positions with respect to a casement window frame, the same are believed to be impractical since the same require substantial modification of the casement window operator and which normally occupy a very large amount of space. Further, the prior art devices are not self-contained

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

The window operator of this invention is designed to attach to the male shaft of the opening mechanism of a casement window by replacing the crank handle which is normally mounted on the male shaft. The unit of this invention may be placed in any window which it is desired to automatically controlled, utilizing an internal self-contained standard or rechargeable battery source. The remotely controlled mechanism of this invention consists of a plastic housing in the shape of an egg or other design, of which, the top half is removable. Inside the housing is a nine volt electric mini-gear-boxed DC motor with a limit switch or time controlling electronic circuit. The internal power supply provides power to operate the motor and the self-contained controlling electronic circuits. The unit includes a circuit board which contains an RF (radio frequency) receiver and a timed overload opening and closing circuit for controlling the operation of the unit.

The unit includes a female socket protruding from the lower end thereof which is splined or slotted to match the geared male shaft on the conventional actuating mechanism of the window. The unit is easily installed on the male shaft after the conventional crank handle has been removed therefrom. The unit also includes a straddling mechanism which straddles the window mechanism to prevent auto-rotation of the unit when activated in either direction.

The unit of this invention opens and closes windows in single or multiple numbers, automatically, with the touch of a button, wirelessly. Through the use of an additional master control panel, it is possible to program the opening and closing of the windows at certain times of the day or night if desired. Preferably, the unit includes a rain sensor which reports, wirelessly, raindrops on the sash and closes the window. Preferably, a wind sensor detects high winds and closes the windows and can reopen them once the conditions clear.

The unit of this invention creates an energy efficient solar radiation control mechanism for businesses or homes. The user may open single windows on one floor or many windows on separate floors for ventilation and energy efficiencies. The opening of windows at night can cool a residence while closing them in the morning can seal in and preserve the cooler night-time temperatures longer during the daylight hours. Elderly persons can open and close the windows with the ease of a button.

It is therefore a principal object of the invention to provide a unique remotely controlled, self-contained mechanism for a window operator for use in moving a casement window sash between open and closed positions with respect to a casement window frame.

A further object of the invention is to provide a unit of the type described which enables a person to open and close one or more windows through a remotely controlled mechanism.

Still another object of the invention is to provide a unit of the type described which is easily attached to the male-splined shaft of a casement window operator once the crank handle has been removed therefrom.

Still another object of the invention is to provide a unit of the type described which may be programmed to open and close windows in the event or rain, wind or other conditions.

Still another object of the invention is to provide a unit of the type described which is easily mounted on a casement window operator.

Still another object of the invention is to provide a unit of the type described which is remotely controlled.

Another principal object of the invention is to provide an opening and closing, clutch-less power automation system for casement windows that is not constructed as part of the window nor permanently affixed to the window, and can be retrofitted to any casement window without the use of tools, alteration of the window sash, additional wiring or permanent fixation, of any kind, and may easily be moved from window to window with little effort by the user.

Still another object of the invention is to provide a unit of the type described that requires no external power source for the operation of the invention, during opening and closing phases. There is no wiring for the operational control between remote control and the unit, with the ability to have from 1 to 99 units placed upon casement windows controlled entirely by one remote control from any location in the home.

Still another object of the invention is to provide a unit of the type described that has the simplistic ease of moving it from one window to another with no tools or required fixation except for the plugging of the unit onto the window operator spindle once the crank handle has been removed.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a partial perspective view of a conventional casement window having a crank handle removably mounted thereon with the RF (radio frequency)-remove control adapted to be mounted on the male splined shaft of the window operator;

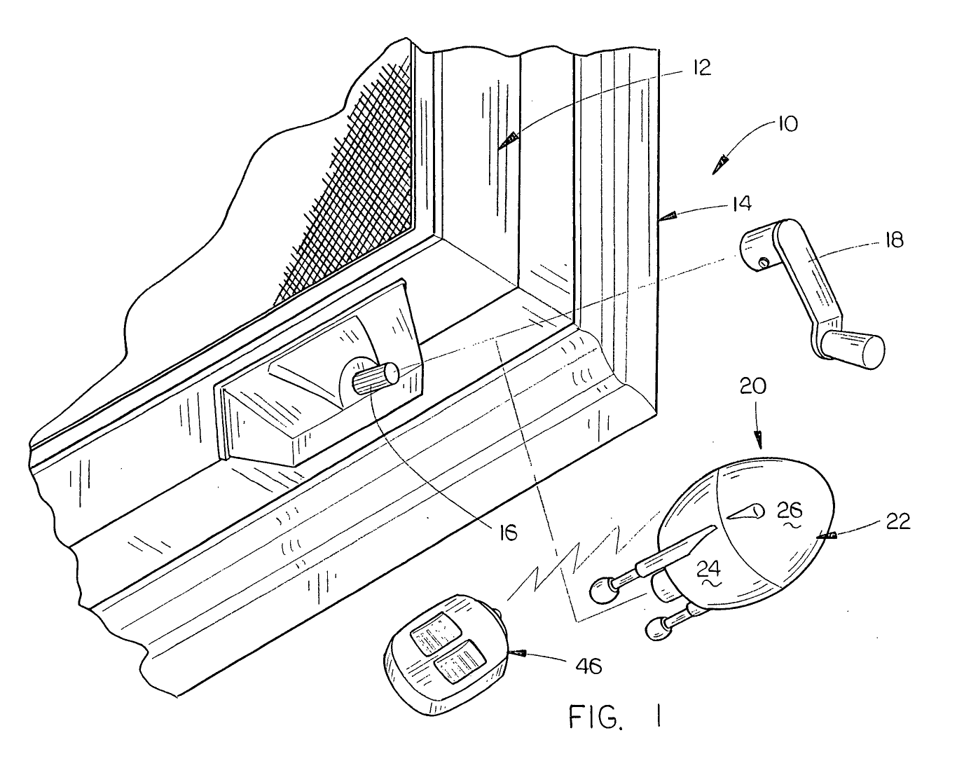

FIG. 2 is an exploded perspective view of the opener of this invention;

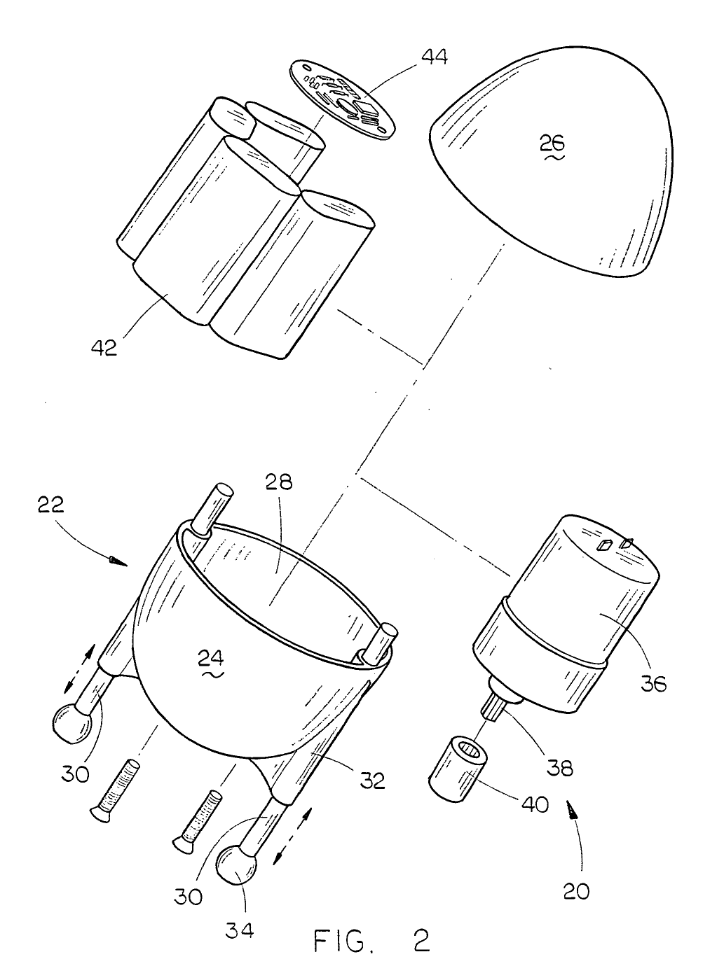

FIG. 3 is a sectional view illustrating the window opener of this invention mounted on the male splined shaft of the opener of the casement window; and

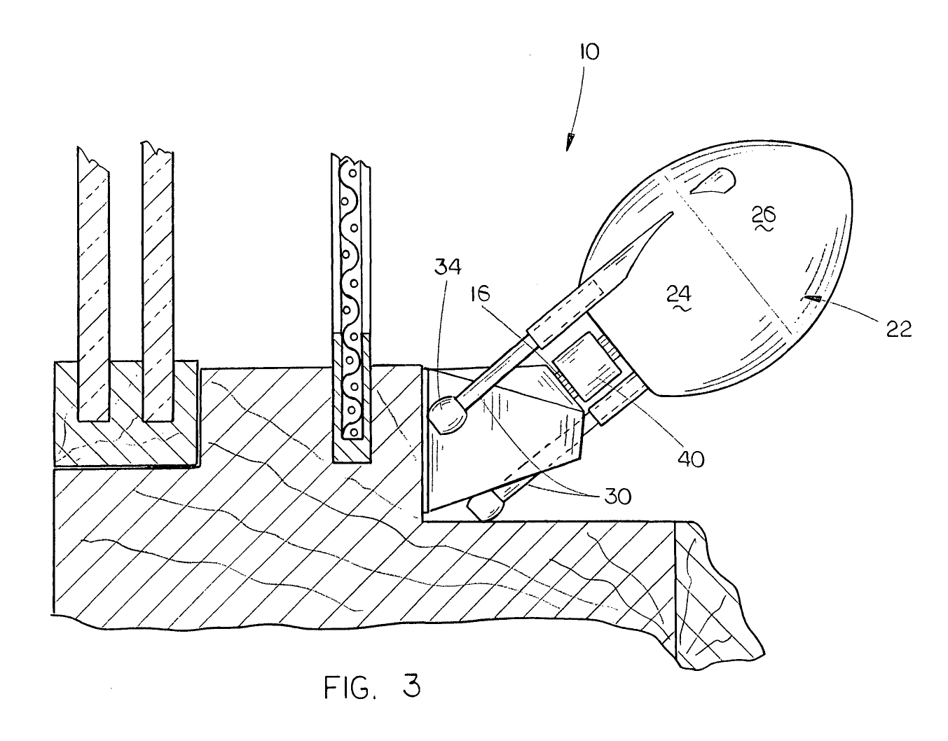

FIG. 4 is a sectional view of the window opener of this invention.

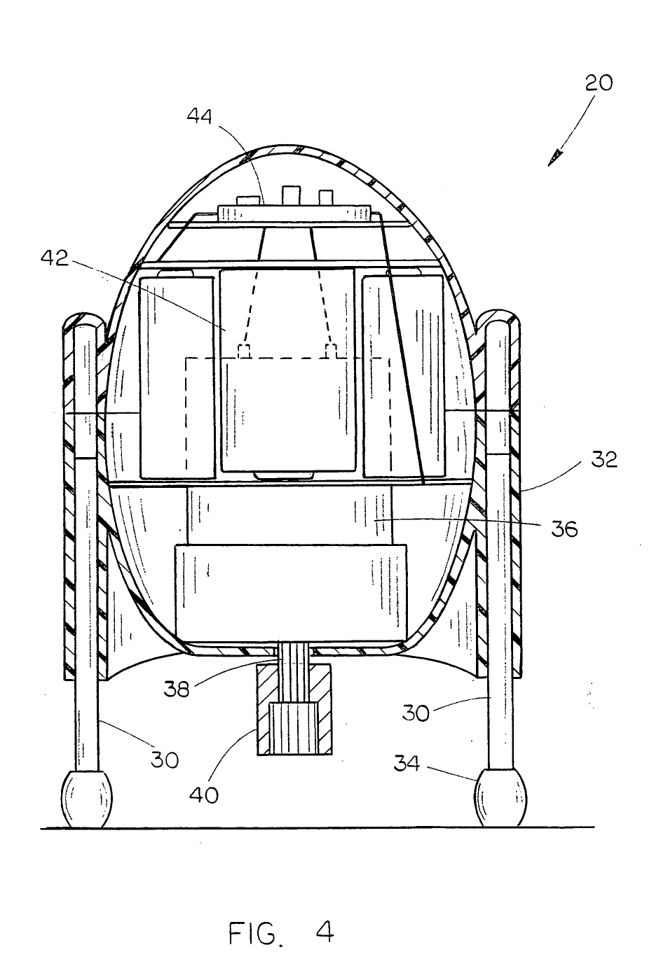

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The numeral 10 refers generally to a conventional casement window including a sash 12 movably mounted in a casement window frame 14. The conventional casement window 10 includes a conventional opener mechanism (not shown) which includes a male splined shaft 16 having a crank handle 18 removably mounted thereon. The opener mechanism normally includes a worm gear which is operatively connected to the shaft 16 with the worm gear being meshed with a gear segment which is part of a lever or linkage assembly that is connected to the sash 12 to move the same between open and closed positions in conventional fashion.

The numeral 20 refers to the self-contained RF (radio frequency)-remote control, automatic window opener of this invention which is adapted to be mounted on the shaft 16 after the crank handle 18 has been removed therefrom. Control 20 is mounted within a housing 22 which may take any different shape but which is preferably egg-shaped, as seen in the drawings. Housing 22 includes a hollow lower housing member 24 and an upper housing member 26 selectively secured to housing member 24 to provide an internal compartment 28. Housing 22 includes a plurality of length adjustable legs 30 which are slidably mounted in tubes or sleeves 32 and which have enlarged foot portions 34, preferably of a soft resilient material, which are adapted to be moved into engagement with the window frame or opener mechanism for anti-rotational purposes, as will be described in greater detail hereinafter. Preferably, housing 22 is fabricated from a plastic material.

The numeral 36 refers to a nine-volt, electric mini-gearboxed DC motor with a limit switch or time controlling electronic circuit. Motor 36 includes a splined drive or power shaft 38 which may be operatively coupled to shaft 16 by any convenient means. If shaft 38 is externally splined, as seen in the drawings, an internally splined collar 40 is mounted on shaft 38 with the other end of collar 40 receiving the shaft 16.

The numeral 42 refers to a nine-volt battery pack which is positioned within the housing 22 and which is electrically connected to motor 36 in conventional fashion and to a RF (radio frequency) circuit board 44 which includes a RF (radio frequency) receiver adapted to receive RF (radio frequency) signals from a remote RF (radio frequency) transmitter 46 in conventional fashion to control the operation of motor 36 in conventional fashion.

When it is desired to convert a conventional casement window so as to be able to be opened through the RF (radio frequency)-remote control, retrofitted, self-contained, opener of this invention, the crank handle 18 is removed from the shaft 16. The control 20 is then mounted on the shaft 16 through the use of the collar 40 or any other conventional means. The adjustable legs 30 are then extended or retracted so as to engage opposite sides of the conventional opener mechanism or the window frame 14 or casement 12 to serve as an anti-rotational mechanism. The unit 20 of this invention may be placed in any window in which it is desired to automatically control, utilizing the self-contained device of this invention. The power supply 42 provides power to operate the motor 36 which contains a limit switch or time controlling electronic circuit. The unit includes the circuit board 44 as described which contains the RF (radio frequency) receiver and the timed overload opening and closing circuit to provide control of the operation of the unit. The unit is easily installed on the shaft 16 after the crank handle 18 has been removed therefrom. The anti-rotational straddling mechanism which is comprised of the adjustable legs 30 prevents auto-rotation of the unit when activated in either direction.

The unit of this invention opens and closes windows in a single or multiple numbers, automatically, with a touch of a button, wirelessly. Through the use of an additional master control panel, it is possible to control the opening and closing of the windows at certain times of the day or night if desired. Preferably, the unit includes a rain sensor which reports, wirelessly, raindrops on the sash 12 and closes the window. Preferably, a wind sensor detects high winds and closes the window or windows and can reopen them once the conditions clear.

The unit of this invention creates an energy efficient solar radiation control mechanism for businesses or homes. The user may open single windows on one floor or many windows on separate floors for ventilation and energy efficiency. The opening of windows at night can cool a residence while closing them in the morning can seal in and preserve the cooler night-time temperatures longer during the daylight hours. Elderly persons can open and close the windows with the ease of a button.

In summary, the uniqueness of this invention over prior art covers several areas of discipline not previously addressed or attenuated by those schooled in the art. First and foremost, the invention is portable, transferable from one window to another and can be accomplished without the use of tools or specialty equipment. The invention does not require manufacturer installation or fabrication nor re-manufacture of the sash to be installed. The invention requires no permanent fixation. There is no marring of the surrounding or adjoining surfaces. When removed, the invention leaves no trace of ever having been previously attached.

The invention contains a self-contained power source. Also contained with the preferred embodiment is a motorized gear box and controlling circuitry. The unit is operated by a hand-held remote control capable of handling from 1 to 99 units. The invention requires no additional wiring, sheetrock repair, sash repair or screwed fixation and does not require additional electrical circuits. There are no clutch mechanisms for the prevention of over stressing the window mechanism, that is accomplished through electronic limit switches.

In addition, the economic considerations are very high. No electrician is required, no additional circuits or breakers are required and no specialized installation technicians are needed. With an average cost of the invention at $50.00 per window, a savings of over $300 per window is easily achieved.

It can therefore be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. In combination with a casement window including a window sash movably mounted in a window frame with the window sash being movable between open and closed positions by a conventional opener mechanism including a drive shaft protruding from the opener mechanism, comprising:
a housing having a DC motor mounted therein which has a selectively reversible power shaft protruding from said housing which is powered by a DC battery source;
said DC battery source being positioned within said housing;
said power shaft adapted to be selectively removably connected to the drive shaft of the opener mechanism whereby the window sash may be moved between its open and closed positions;
an electrical circuit in said housing for controlling the operation of said motor;
a RF (radio frequency) receiver associated with said circuit;
and a remote RF (radio frequency) transmitter which is capable of sending RF (radio frequency) signals to said RF (radio frequency) receiver to remotely open and close the window sash.

2. The combination of claim 1 wherein said housing has a plurality of anti-rotation members slidably extending therefrom for engagement with the window frame without extending thereinto.

3. The combination of claim 2 wherein said anti-rotation members are selectively slidably mounted in said housing so as to be length adjustable.

4. The combination of claim 1 wherein said housing comprises at least a pair of hollow housing members which are selectively secured together.

5. The combination of claim 1 wherein said power shaft may be selectively disconnected from the drive shaft of the opener mechanism so that the housing and associated components may be selectively used with other casement windows.
